(19) United States
(12) Patent Application Publication
(10) Pub. No.: US 2026/0105705 A1
(43) Pub. Date: Apr. 16, 2026

(54) METHOD OF GENERATING EFFECT VIDEO ELECTRONIC DEVICE AND STORAGE MEDIUM

(71) Applicant: Beijing Zitiao Network Technology Co., Ltd., Beijing (CN)

(72) Inventors: Jiaxin MA, Beijing (CN); Sijing WEN, Beijing (CN); Bingyan LIANG, Beijing (CN); Xiaochan WANG, Beijing (CN)

(21) Appl. No.: 19/115,753

(22) PCT Filed: Sep. 15, 2023
(86) PCT No.: PCT/CN2023/119023

§ 371 Date: Mar. 26, 2025

(30) Foreign Application Priority Data
Sep. 29, 2022 (CN) 202211204819.0

(51) Int. Cl. G06T 19/20; G06T 3/40; G06T 7/11; G06V 10/764; G06V 20/40; G06V 40/16; G10H 1/00; G10H 1/36; G11B 27/031

(52) U.S. Cl. CPC G06T 19/20; G06T 3/40; G06T 7/11; G06V 10/764; G06V 20/40; G06V 40/161; G10H 1/0008; G10H 1/36; G11B 27/031; G06T 2207/10016; G06T 2207/30201; G06T 2219/2004; G10H 2210/005; G10H 2210/056

(57) ABSTRACT

Embodiments of the present disclosure provide a method and apparatus for generating an effect video, an electronic device and a storage medium. The method includes: in response to detecting that a sound-mixing condition is met, determining at least one sound-mixing audio corresponding to at least one target object within a video frame to be processed; determining a target audio for the video frame to be processed based on the at least one sound-mixing audio and audio information of the at least one target object; and determining an effect video frame corresponding to the video frame to be processed based on the target audio and the at least one target object.

### CROSS-REFERENCE TO RELATED APPLICATION(S)

This application claims priority to Chinese Application No. 202211204819.0, filed in the China Patent Office on Sep. 29, 2022, and the disclosure of which is incorporated herein by reference in its entity.

### FIELD

Embodiments of the present disclosure relate to the image processing technology, for example, relates to a method and apparatus for generating an effect video, an electronic device and a storage medium.

### BACKGROUND

With the development of the network technology, more and more application programs come into the life of users, for example, a series of software capable of filming short videos are deeply loved by the users.

Software developers may add a variety of effect props in the applications for the use of the users during video filming processes, however, the richness of these effect props is insufficient, and thus cannot completely meet the requirements of the users.

### SUMMARY

The present disclosure provides a method and apparatus for generating an effect video, an electronic device and a storage medium, which achieve the technical effect of performing effect processing on an audio to enrich a special-effect presentation effect, thereby improving the user experience.

In a first aspect, an embodiment of the present disclosure provides a method for generating an effect video, including:
determining, in response to detecting that a sound-mixing condition is met, at least one sound-mixing audio corresponding to at least one target object within a video frame to be processed, wherein the video frame to be processed is a video frame collected in real time or a video frame in a recorded video;
determining a target audio for the video frame to be processed based on the at least one sound-mixing audio and audio information of the at least one target object; and
determining an effect video frame corresponding to the video frame to be processed based on the target audio and the at least one target object.

In a second aspect, an embodiment of the present disclosure further provides an apparatus for generating an effect video, including:
a sound-mixing audio determination module, configured to: determine, in response to detecting that a sound-mixing condition is met, at least one sound-mixing audio corresponding to at least one target object within a video frame to be processed, wherein the video frame to be processed is a video frame collected in real time or a video frame in a recorded video;
a target audio determination module, configured to: determine, based on the at least one sound-mixing audio and audio information of the at least one target object, a target audio for the video frame to be processed; and
an effect video frame determination module, configured to: determine an effect video frame corresponding to the video frame to be processed based on the target audio and the at least one target object.

In a third aspect, an embodiment of the present disclosure further provides an electronic device, including:
one or more processors; and
a storage apparatus, configured to store one or more programs,
wherein the one or more programs. when executed by the one or more processors, cause the one or more processors to implement the method for generating the effect video according to any of the embodiments of the present disclosure.

In a fourth aspect, an embodiment of the present disclosure further provides a storage medium, including computer-executable instructions, wherein the computer-executable instructions, when executed by a computer processor, is configured to perform the method for generating the effect video according to any of the embodiments of the present disclosure.

### BRIEF DESCRIPTION OF THE DRAWINGS

Throughout the drawings, the same or similar reference signs indicate the same or similar elements. It should be understood that the drawings are schematic and that original members and elements are not necessarily drawn to scale.

FIG. 1 is a schematic flowchart of a method for generating an effect video provided in an embodiment of the present disclosure;

FIG. 2 is a user display interface of an application program for generating an effect video provided in an embodiment of the present disclosure;

FIG. 3 is a schematic diagram of an interface for generating an effect video provided in an embodiment of the present disclosure;

FIG. 4 is a schematic flowchart of another method for generating an effect video provided in an embodiment of the present disclosure;

FIG. 5 is a schematic flowchart of another method for generating an effect video provided in an embodiment of the present disclosure;

FIG. 6 is a schematic diagram of a display position of at least one target object provided in an embodiment of the present disclosure;

FIG. 7 is a schematic diagram of another display position of at least one target object provided in an embodiment of the present disclosure;

FIG. 8 is a schematic diagram of another display position of at least one target object provided in an embodiment of the present disclosure;

FIG. 9 is a schematic diagram of a display position of a segmentation image provided in an embodiment of the present disclosure;

FIG. 10 is a schematic diagram of another display position of a segmentation image provided in an embodiment of the present disclosure;

FIG. 11 is a schematic diagram of another display position of a segmentation image provided in an embodiment of the present disclosure;

FIG. 12 is a schematic flowchart of another method for generating an effect video provided in an embodiment of the present disclosure;

FIG. 13 is a schematic diagram of a display position of a three-dimensional (3D) microphone provided in an embodiment of the present disclosure;

FIG. 14 is a schematic structural diagram of an apparatus for generating an effect video provided in an embodiment of the present disclosure; and

FIG. 15 is a schematic structural diagram of an electronic device provided in an embodiment of the present disclosure.

### DETAILED DESCRIPTION OF EMBODIMENTS

Hereinafter, embodiments of the present disclosure will be described in more detail with reference to the drawings. Although some embodiments of the present disclosure have been illustrated in the drawings, it should be understood that the present disclosure may be implemented in various forms and should not be construed as being limited to the embodiments set forth herein. The drawings and embodiments of the present disclosure are for exemplary purposes only and are not intended to limit the protection scope of the present disclosure.

A plurality of steps recorded in method implementations of the present disclosure may be executed in different sequences and/or in parallel. In addition, the method implementations may include additional steps and/or omit executing the steps shown. The scope of the present disclosure is not limited in this respect.

As used herein, the terms “include” and variations thereof are open-ended terms, i.e., “including, but not limited to”. The term “based on” is “based, at least in part, on”. The term “one embodiment” means “at least one embodiment”; the term “another embodiment” means “at least one additional embodiment”; and the term “some embodiments” means “at least some embodiments”. Relevant definitions of other terms will be given in the following description.

Concepts such as “first” and “second” mentioned in the present disclosure are only intended to distinguish different apparatuses, modules or units, and are not intended to limit the sequence or interdependence of functions executed by these apparatuses, modules or units.

Modifiers such as “one” and “more” mentioned in the present disclosure are intended to be illustrative and not restrictive, and those skilled in the art should understand that the modifiers should be interpreted as “one or more” unless the context clearly indicates otherwise.

The names of messages or information interacted between a plurality of apparatuses in the implementations of the present disclosure are for illustrative purposes only and are not intended to limit the scope of these messages or information.

Before the technical solutions disclosed in a plurality of embodiments of the present disclosure are used, the type, the use range, the use scenario and the like of personal information involved in the present disclosure should be notified to the user in an appropriate manner according to relevant laws and regulations, and the authorization of the user is obtained.

For example, in response to receiving an initiative request of the user, prompt information is sent to the user to explicitly prompt the user that an operation which the user requests to execute needs to acquire and use the personal information of the user. Therefore, the user can autonomously select, according to the prompt information, whether to provide the personal information for software or hardware, such as an electronic device, an application program, a server, or a storage medium, which executes the operations in the technical solutions of the present disclosure.

As an optional but non-restrictive implementation, the manner of sending the prompt information to the user in response to receiving the initiative request of the user may be, for example, a pop-up window, and the prompt information may be presented in the pop-up window in the form of text. In addition, the pop-up window may further carry a selection control for the user to select “Agree” or “Disagree” to provide the personal information for the electronic device.

The above processes of notifying the user and acquiring the authorization of the user are merely illustrative, and do not constitute limitations on the implementations of the present disclosure, and the other methods meeting the relevant laws and regulations may also be applied to the implementations of the present disclosure.

Data (including, but not limited to, the data itself, the acquisition or use of the data) involved in the present technical solution should follow the requirements of corresponding laws and regulations and related regulations.

Before the present technical solution is introduced, an application scenario is described at first as an example. The technical solution of the present disclosure may be applied to any scenario in which effect presentation or effect processing is required, for example, may be applied to a video filming process to perform effect processing on a filmed target object; and the technical solution may also be applied after the video filming process, for example, in a case where after a video is filmed by a camera of a terminal device, effect presentation may be performed on the pre-filmed video. In the present implementation, the target object may be a user or any object that may send audio information.

The technical method provided in the embodiments of the present disclosure may be applied to a real-time collection scenario, and may also be applied to a post-processing scenario. In the real-time collection scenario, it can be understood that every time when a video frame is collected, the video frame is used as a video frame to be processed, and an effect video frame corresponding to the video frame to be processed is determined based on the technical method provided in the embodiments of the present disclosure; and in the post-processing scenario, each video frame in an uploaded video may be sequentially used as the video frame to be processed. In order to introduce the technical method provided in the embodiments of the present disclosure, the processing of one video frame is taken as an example for description, and the processing of the remaining video frames may repeatedly execute the steps provided in the embodiments of the present disclosure.

An apparatus for executing a method for generating an effect video provided in the embodiments of the present disclosure may be integrated into application software supporting an effect video processing function, and the software may be installed in an electronic device, and optionally, the electronic device may be a mobile terminal or a personal computer (PC), etc. The application software may be one software for image/video processing, and the specific application software is not described herein again, as long as the image/video processing may be implemented. The apparatus for executing the method for generating the effect video provided in the embodiments of the present disclosure may also be a specially developed application program, which is located in software for adding an effect and presenting the effect, and may also be integrated in a corresponding page, and the user may process the effect video by using a page integrated in the PC.

FIG. 1 is a schematic flowchart of a method for generating an effect video provided in an embodiment of the present disclosure. The embodiment of the present disclosure is applicable to a case of performing effect processing on an audio, the method may be executed by an apparatus for generating an effect video, and the apparatus may be implemented in the form of software and/or hardware, optionally, is implemented by an electronic device, and the electronic device may be a mobile terminal, a PC, a server, or the like. The technical solutions provided in the embodiment of the present disclosure may be executed by a server, or may be executed by a client, or may be executed by the cooperation of the client and the server.

As shown in FIG. 1, the method includes:
S110: in response to detecting that a sound-mixing condition is met, determining at least one sound-mixing audio corresponding to at least one target object within a video frame to be processed.

The sound-mixing condition may be understood as a condition for determining whether it is necessary to perform effect processing on an audio for the video frame to be processed.

In the embodiment of the present disclosure, the sound-mixing condition may include a plurality of cases, and whether to process audio information in the video frame to be processed may be determined based on whether the current trigger operation meets a corresponding case.

Optionally, the cases included in the sound-mixing condition may be: triggering an effect prop corresponding to a sound-mixing effect; a display interface includes at least one target object; triggering a filming control; and detecting a recorded video that is uploaded based on a triggered video processing control.

In the present embodiment, the first manner of determining the sound-mixing condition is triggering the effect prop corresponding to the sound-mixing effect, which may be understood as: performing compression processing on a program code or processing data based on the technical method provided in the embodiments of the present disclosure, so that the program code or the processing data is integrated into some application software as an effect packet, so as to serve as the effect prop. When the effect prop is triggered, it indicates that it is necessary to perform effect processing on the audio in the collected video frame to be processed, and at this time, the audio mixing condition is met.

The second manner of determining the sound-mixing condition is that the display interface includes the at least one target object, regardless of a video frame collected in real time or a non-real-time video frame, as long as a lens-entry picture is detected, that is, the video frame to be processed includes the target object, at this time, it is considered that the sound-mixing condition is met. The target object may be preset. For example, the target object may be a user, as long as it is detected that there is a user in the display interface, a computer considers that the sound-mixing condition is met.

The third manner of determining the sound-mixing condition is triggering the filming control, and the filming control may be used as a trigger condition, wherein the filming control is pre-written, when an image is filmed by a filming apparatus, if the filming control is clicked on, it indicates that the sound-mixing condition is met, and at this time, as long as the collected video frame to be processed includes audio content, it is necessary to perform effect processing on the audio.

The fourth manner of determining the sound-mixing condition is detecting the recorded video that is uploaded based on the triggered video processing control, the present solution can not only achieve a real-time processing effect, but can also perform post-processing, when the uploaded recorded video is received, it indicates that the video needs to be processed, and the effect processing may be performed on the video based on the method in the embodiments of the present disclosure.

In the present embodiment, during the process of determining the video frame to be processed, two manners are mainly involved: a video frame collected in real time and a video frame in the recorded video respectively, and the two determination manners may include a plurality of sound-mixing conditions. The advantages of such settings lie in that: no matter the user determines the video frame to be processed in which manner, the sound-mixing audio corresponding to the target object in the video frame to be processed may be determined by the plurality of sound-mixing conditions, so that the application range of the present solution is wider.

The video frame to be processed may be determined based on a real-time filmed video, and may also be determined based on a non-real-time filmed video. As long as the audio mixing condition is met, the video frames of a video collected in real time or an uploaded video may be processed in sequence, and each video frame may be used as the video frame to be processed. Another case is that if the effect processing is performed on some video frames under optional conditions, each selected video frame may be used as the video frame to be processed.

The target object is a user presented in the video frame to be processed, the number of the target objects may be one or more, and the number of the target objects may be preset according to actual situations. For example, if it is preset that objects in all lens-entry pictures are used as the target objects, the number of the target objects corresponds to the number of users in the lens-entry picture; and if it is only necessary to perform effect processing on some specific users, facial images corresponding to the objects may be uploaded in advance, so that when the lens-entry picture includes a plurality of display objects, the target objects may be determined based on uploaded facial information and the facial information of display objects. In addition, in another manner, the target object is determined based on a trigger operation of a target user on a display interface. For example, there are a plurality of objects on the display interface, and the objects triggered and selected by the target user may be used as the target object. That is, it is only required to perform effect processing on the triggered and selected target object.

Sound mixing may be understood as integrating sounds of a plurality of sources into a stereo audio track or a single audio track. The sources of the plurality of sounds may be audios of different voice parts corresponding to different users. Therefore, the sound-mixing audio may be understood as an audio corresponding to different voice parts in the same song sung by a plurality of players. For example, at least one song is preset, and a plurality of sound-mixing audios may be determined based on the plurality of users. Sound-mixing audios adapted to different users may be produced in advance, for example, the sound-mixing audios may be distinguished according to age stages, may be distinguished according to gender attributes, and may also be distinguished according to tones. If distinguished according to the age stages, the sound-mixing audios may be divided into children, juvenile, youngsters, adults or old people; if distinguished according to the gender attributes, the sound-mixing audios may be divided into male voice parts and female voice parts; and if distinguished according to the tones, the sound-mixing audios may be divided into high-pitch voice parts, alto voice parts or low-pitch voice parts. In an actual usage process, one or more songs may be preset, and sound-mixing audios corresponding to a plurality of dividing standards may be determined based on the preset one or more songs for the use of the target user. The number of the sound-mixing audios may correspond to the number of the target objects, or the sound-mixing audio may be selected by triggering.

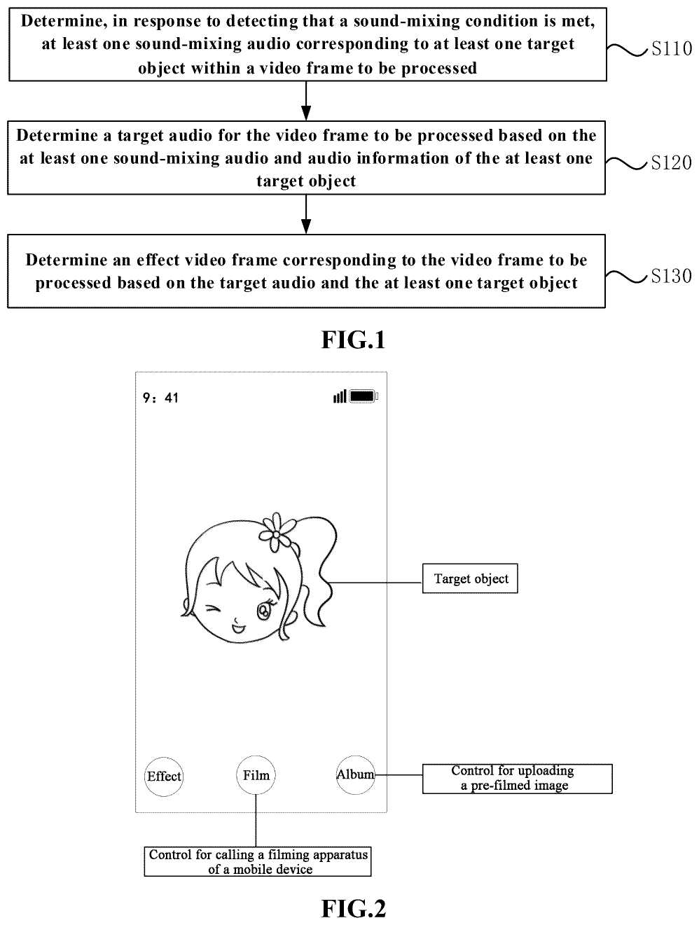

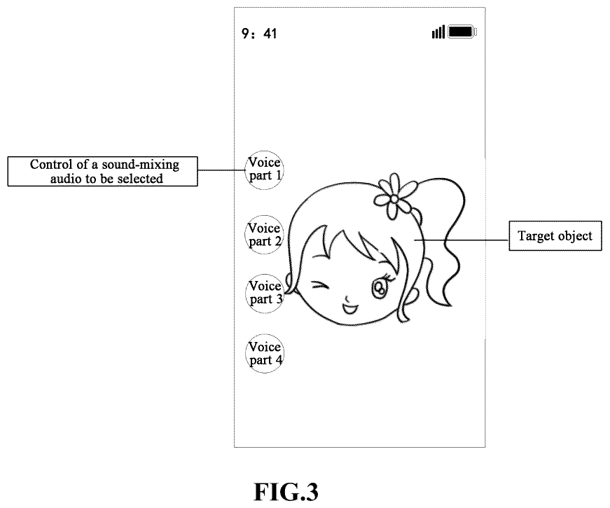

For example, when triggering an application software or application program, the target user enters a target user display interface of the application program for generating the effect video, referring to FIG. 2. As shown in FIG. 2, a control located at the middle of the lowest bottom of the display interface is a control for calling a filming apparatus of a mobile device, when the target user triggers the control named “filming”, the mobile terminal device starts the filming apparatus for filming, at this time, a user image may be filmed, a video frame in a video filmed in the mobile terminal device is the video frame to be processed, and the filmed user may be the target object, so that the sound-mixing audio corresponding to the target object may be determined. A control corresponding to a sound-mixing effect prop may also be preset, an effect prop control is triggered to serve as the sound-mixing condition, and one display interface of the sound-mixing condition may be as shown in FIG. 3. As shown in FIG. 3, a control for triggering and selecting a sound-mixing audio to be selected may be set in the interface, for example, controls corresponding to “Voice part 1”, “Voice part 2”, “Voice part 3” and “Voice part 4” in FIG. 3, when the target user triggers any control in the controls of the sound-mixing audio to be selected, it indicates that the target user selects the sound-mixing audio corresponding to the control, and in an actual application process, the target user may trigger the controls of all sound-mixing audios to be selected displayed in the display interface, and if a plurality of controls are triggered, a plurality of sound-mixing audios may be determined. In addition, as shown in FIG. 2, a control located at the lower right of the display interface is a control for uploading a pre-filmed video, and when the target user triggers a control named “album”, it skips to an album browsing interface, the pre-filmed video may be found and selected from the album of the mobile device, and the selected pre-filmed video is displayed in the display interface of the video frame to be processed, and the user in the video frame to be processed may serve as the target object, and the sound-mixing audio corresponding to the target object may be determined.
S120: determining a target audio for the video frame to be processed based on the at least one sound-mixing audio and audio information of the at least one target object.

The audio information is audio data that is collected by an audio collection module, for example, a microphone array, and corresponds to the target object. The target audio may be understood as: after the sound-mixing audio and the audio data corresponding to the target object are determined, dual-track audio playing is performed thereon. For example, the determined sound-mixing audio is a child voice part, the actually collected audio information is a youngster audio, the child voice part and the youngster audio may be used as a dual-track audio to be played as the target audio together.

For example, referring to FIG. 3, if the sound-mixing control displayed in the display interface corresponds to the voice part 1, the voice part 2, the voice part 3, the voice part 4 and the like, based on a trigger operation of the target user on these controls, if the voice part 1 and the voice part 2 are triggered, the voice part 1 and the voice part 2 are used as the sound-mixing audio, and the voice part 1, the voice part 2, and the audio information corresponding to the target object are jointly used as the target audio.

In the present embodiment, the attribute corresponding to each target object is different, for example, the target object may be a senior, an adult or a child, and the audio information of all objects and the sound-mixing audio may be collectively used as the target audio, and the target audio is played based on a loudspeaker. If it is desired to embody an effect of simultaneous singing of a plurality of persons, the audio information of all objects and the sound-mixing audio may be directly played as multiple audio tracks, and if it is desired to embody an audio signal of one target object, at this time, a control may be set in the display interface, and the control is used for selecting to play the audio information of which target user. For example, regarding a target object A and a target object B, if it is desired to only embody the audio signal of the target object A, at this time, a control may be set near the target object A in the display interface, and this control may be triggered to select to only play the audio signal of the target object A, and silencing processing may be performed on the audio signal of the target user B.

Song text information corresponding to the sound-mixing audio song may also be displayed in the display interface, so as to guide the target user to read, sing or broadcast based on the song text information.
S130: determining an effect video frame corresponding to the video frame to be processed based on the target audio and the at least one target object.

In the present embodiment, the effect video frame is a video frame that simultaneously presents the target object and the target audio. The target audio includes the sound-mixing audio and the audio information of the target object, and the target object corresponds to image information in the video frame. Based on the determined target audio, the target object corresponding to the target audio is simultaneously displayed in the display interface, so that a presentation picture of the target object is consistent with the target audio, so as to obtain the effect video frame.

For each video frame to be processed, fusion processing is performed on the target audio and the target object to obtain each effect video frame, and finally a plurality of effect video frames are spliced in time to obtain an effect video.

According to the technical solutions of the embodiments of the present disclosure, in response to detecting that the sound-mixing condition is met, the at least one sound-mixing audio corresponding to the at least one target object in the video frame to be processed may be determined, then the target audio corresponding to a plurality of audio tracks may be determined based on the determined sound-mixing audio and the audio information of the at least one target object, and the final effect video frame may be obtained by performing fusion processing on the target audio and the target object. The technical effects of not only processing picture content, but also processing audio content can be realized, the richness and interestingness of a special-effect presentation effect are improved, and the technical effect of improving the use experience of the target user is further improved.

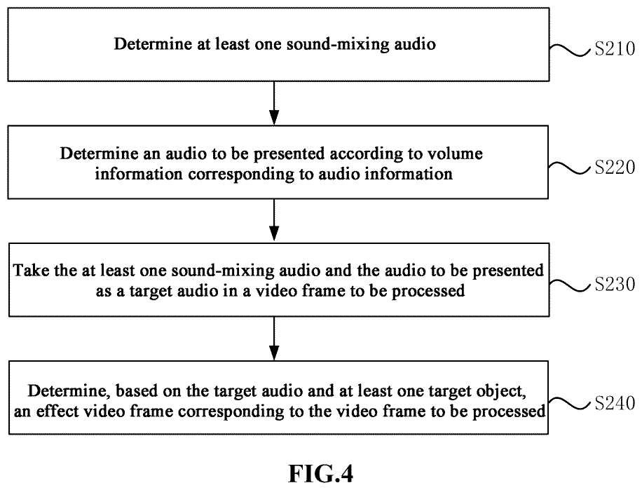

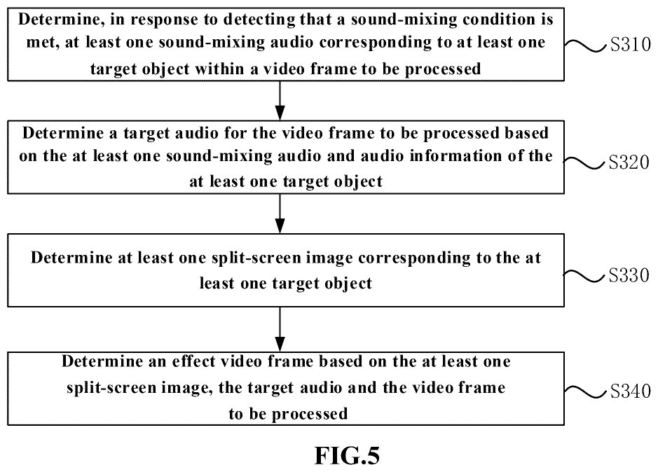

FIG. 4 is a schematic flowchart of a method for generating an effect video provided in an embodiment of the present disclosure. Based on the foregoing embodiments, determining the sound-mixing audio corresponding to the target object in the video frame to be processed may be implemented in a plurality of manners, and during the process of determining the target audio, the target audio may be determined according to volume information corresponding to the audio information. For a specific implementation, reference may be made to the technical solutions in the present embodiment. Technical terms the same as or corresponding to those in the above embodiments are not described herein again.

As shown in FIG. 4, the method includes the following steps:
S210: determining at least one sound-mixing audio.

In the embodiment of the present disclosure, there may be a plurality of manners for determining the at least one sound-mixing audio, and how to implement each manner is described below.

The first implementation is to determine the at least one sound-mixing audio based on a trigger operation on at least one sound-mixing control on the display interface.

In the present embodiment, the manner of determining the sound-mixing audio based on the trigger operation for the sound-mixing control on the display interface is applicable to a case where the video frame to be processed is a video frame collected in real time or a video frame in a recorded video. When the target user triggers an effect prop corresponding to a sound-mixing effect in the display interface, a sound-mixing sound effect corresponding to the control may be directly selected according to the prompt of the control in the display interface, and the target user may select a plurality of sound-mixing controls, and at this time, the number of the determined sound-mixing audios corresponds to the number of the sound-mixing controls triggered by the target user. For example, in FIG. 3, the target user triggers a control of the voice part 1 in the display interface, and at this time, it may be directly determined that the sound-mixing sound effect is audio content of the voice part 1; and if the target user triggers controls corresponding to the voice part 1, the voice part 2 and the voice part 3 in the interface within a preset duration, audio content corresponding to the voice part 1, the voice part 2 and the voice part 3 may be used as sound-mixing audios. It may be preset that whether to select the voice part corresponding to a control of an effect prop is determined according to the number of times for triggering the control of the effect prop. For example, if the number of times of the target user triggering the control of the effect prop is an odd number, for example, the number of times of the target user triggering the control of the effect prop is one or three, it indicates that the voice part corresponding to the current control is selected; if the number of times of the target user triggering the control of the effect prop is an even number, for example, the number of times of the target user triggering the control of the effect prop is two or four, at this time, it indicates that the user has triggered the control of the effect prop once, if the same control is triggered based on the triggered control, it indicates that the target user performs a cancel operation on the voice part corresponding to the current control, that is, the voice part corresponding to the current control is not used as a final sound-mixing audio to be presented.

The second implementation is to determine the at least one sound-mixing audio according to object attributes of the at least one target object.

In the present embodiment, the manner of determining the sound-mixing audio according to the object attributes of the target object is applicable to the case where the video frame to be processed is the video frame collected in real time or the video frame in the recorded video. In the present embodiment, the target object may have a plurality of attributes, for example, different attributes may be distinguished in terms of genders, and different attributes may also be distinguished from age stages. Since the attributes of the target objects are different, the sound-mixing audios determined according to the attributes of the target objects are also different. Optionally, the method for determining the at least one sound-mixing audio according to the object attributes of the at least one target object may include: identifying the object attributes of the at least one target object based on a facial detection algorithm; based on the number of attribute categories of the object attributes and the object attributes, determining sound-mixing audios consistent with the number of attribute categories from at least one pre-made sound-mixing audio to be selected. The advantages of such settings lie in that: the sound-mixing audio determined based on a facial recognition algorithm in combination with the number of attribute categories has a higher matching degree with the target object in a video to be processed, and a more vivid effect presentation performance is achieved.

In the present embodiment, if it is detected according to a facial recognition algorithm that the number of attribute categories in the display interface is greater than 1, the sound-mixing audio may be determined based on the total number of attribute categories and a multi-person sound-mixing audio. For example, if it is detected that the object attribute in the display interface includes one male and one female at the same time, in this case, the number of attribute categories of the object attribute is 2, and during the process of determining the sound-mixing audio, a sound-mixing audio of the male, a sound-mixing audio of the female and a multi-person sound-mixing audio may be called. In an actual application process, it is detected that the object attribute in the display interface may be a plurality of males and a plurality of females, but at this time, the number of attribute categories of the object attribute is still 2, at this time, the sound-mixing audios of the plurality of males will not be repeatedly called, the sound-mixing audios of the plurality of females will not be repeatedly called, and the sound-mixing audio of one male, the sound-mixing audio of one female and the multi-person sound-mixing audio are only determined.

For example, according to the facial recognition algorithm, if it is detected that the target object in the display interface is a child, the sound-mixing audio corresponding to the video frame to be processed may be set to be a pre-configured child voice part; and if it is detected that the target object in the display interface is a senior, the sound-mixing audio corresponding to the video frame to be processed may be set to be a pre-configured senior voice part; and if the pre-made sound-mixing audios to be selected include a child voice part, a juvenile voice part, a youngster voice part, an adult voice part and an senior voice part, in response to detecting that the target objects in the display interface are a child and a senior, the child voice part and the senior voice part are determined from the pre-made sound-mixing audio to serve as the sound-mixing audios, so that the number of the determined sound-mixing audios is two, the attribute categories of the object attribute include the child and the senior, so that the number of attribute categories of the object attribute is 2, therefore at this time, the number of attribute categories of the object attribute is consistent with the number of sound-mixing audios; and if the pre-made sound-mixing audios to be selected include a child voice part, a juvenile voice part, a youngster voice part, an adult voice part, an senior voice part and a multi-person voice part, in response to detecting that the target objects in the display interface are a child and a senior, the child voice part, the senior voice part and the multi-person voice part are determined from the pre-made sound-mixing audios to serve as the sound-mixing audios, that is, it is identified that the target objects are a plurality of persons, so that the sound-mixing audios need to include the multi-person voice part.

The third implementation is to determine the at least one sound-mixing audio according to audio information in the video frame to be processed.

In the present embodiment, the manner of determining the at least one sound-mixing audio according to the audio information in the video frame to be processed is applicable to a case where the video frame to be processed is a video frame in the recorded video. The determined video frame to be processed may include original audio information in the video frame, the original audio information may indicate the content of a song that the target user wants to sing, at this time, the audio information in the video frame may be identified at first to determine the sound-mixing audio associated with the audio information in the video frame, thereby achieving the effect of meeting the personalized requirements of the target user.

Optionally, a harmony melody is determined according to accompaniment information of the audio information in the video frame to be processed and a target voice part in the harmony; and the at least one sound-mixing audio is determined based on tone information in the harmony melody and tone information in the audio information.

The target voice part may be a high-pitch voice part or a low-pitch voice part of the harmony in the video frame to be processed, or the harmony melody of a syllable, and may also be a voice part corresponding to a pre-calibrated syllable. The harmony melody may be a melody associated with the voice part of the audio information in the video frame to be processed. For example, in a music creation process, if the tones of songs are different, the melodies corresponding to the songs may also be changed, and the harmony melodies of different voice parts are also different. For example, the harmony of the music includes a high-pitch voice part harmony, an alto voice part harmony and a low-pitch voice part harmony, wherein the harmony melody of the high-pitch voice part harmony is a melody A, the harmony melody of the alto voice part harmony is a melody B, the harmony melody of the low-pitch voice part harmony is a melody C, and the melody A, the melody B and the melody C are different melodies.

The accompaniment information of the audio information in the video frame to be processed is acquired at first, for example, if the audio information in the video frame to be processed is an audio of improvisational humming of the user, the accompaniment information of the audio may be acquired by an accompaniment detection algorithm, and then a corresponding chord is matched for the accompaniment by a chord matching algorithm, so as to obtain the accompaniment information of the audio information in the video frame to be processed. Then, the target voice part in the harmony of the audio information in the video frame to be processed is acquired, and the target voice part may be a voice part corresponding to the harmony in the video frame to be processed. For example, if the voice part in the harmony of the audio information in the video frame to be processed is a low-pitch voice part, then the target voice part is a low-pitch voice part; if the voice part in the harmony of the audio information in the video frame to be processed is an alto voice part, then the target voice part is an alto voice part; and if the voice part in the harmony of the audio information in the video frame to be processed is a high-pitch voice part, then the target voice part is a high-pitch voice part. Finally, the harmony melody is determined based on the accompaniment information and the target voice part in the harmony. For example, if it is determined that the target voice part in the harmony is a low-pitch voice part, then the chord position in an accompaniment chord may be reduced, and then the harmony melody of the low-pitch voice part is obtained; and if it is determined that the target voice part in the harmony is a high-pitch voice part, the chord position in the accompaniment chord may be increased, and then the harmony melody of the high-pitch voice part is obtained. The tone information in the harmony melody and the tone information in the audio information in the video frame to be processed may jointly reflect the audio in the humming of the original audio information in the video frame to be processed belongs to which song, then an audio related to the song is determined from preset sound-mixing audios to serve as the sound-mixing audio, and at this time, the determined sound-mixing audio is highly related to the original audio information in the video frame to be processed.

For example, it is assumed that the audio information in the video frame to be processed is an audio corresponding to a song A, the accompaniment information of the audio is acquired at first by the accompaniment detection algorithm, and then a corresponding chord is matched for the accompaniment by the chord matching algorithm, so as to obtain the accompaniment information of the song A in the video frame to be processed; and then, the target voice part of the song A in the video frame to be processed is acquired as a low-pitch voice part, at this time, the chord position in the accompaniment chord may be reduced, so as to obtain the harmony melody of the low-pitch voice part. Since the tones of songs are different, the melodies corresponding to the songs may also be changed, and the harmony melodies of different voice parts are also different, so that the tone information in the harmony melody may represent a specific song corresponding to the tone information in the audio information in the video frame to be processed, and when the sound-mixing audio is determined, the audio related to the song A is selected as the sound-mixing audio.

Based on the above embodiments, the at least one sound-mixing audio is determined based on the tone information in the harmony melody and the tone information in the audio information. The advantages of such settings lie in that: the sound-mixing audio associated with the actual audio information in the video frame to be processed is determined according to the actual audio information of the target object, so that the personalized requirement of the target user can be met.

Optionally, determining the at least one sound-mixing audio based on the tone information in the harmony melody and the tone information in the audio information includes: determining the at least one sound-mixing audio based on the tone information in the harmony melody, the tone information in the audio information, and the object attributes of the at least one target object.

Based on the above embodiments, in addition to determining the at least one sound-mixing audio according to the tone information in the harmony melody and the tone information in the audio information, the object attributes of the target object may also be used as a consideration factor for determining the sound-mixing audio. For example, the song A may be determined according to the tone information in the harmony melody and the tone information in the audio information, if the object attribute of the target object is a child, the sound-mixing audio may include audio content of singing the song A in the child voice part. The advantages of such settings lie in that: the sound-mixing audio associated with the actual audio information in the video frame is determined according to the object attribute of the target object, so that the finally played target audio can better match an image in the display interface on the basis of meeting the personalized requirements of the target user.

Optionally, the sound-mixing audio includes a harmony accompaniment of at least one voice part, or the sound-mixing audio includes a harmony accompaniment of at least one voice part and an audio of a lead-singer audio track.

In the present embodiment, the sound-mixing audio may be an audio having two different presentation modes. One presentation mode is to include a harmony accompaniment of one or more voice parts; and the other presentation mode is to not only include the harmony accompaniment of one or more voice parts, but also include the audio of the lead-singer audio track, that is, the content of the sound-mixing audio may be only an accompaniment music, and may also be a music in which the accompaniment music is combined with the lead-singer audio track. The advantages of such settings lie in that: there are a plurality of sound-mixing audio composition manners, thereby providing more alternative playing modes for the user, thus improving the richness and interestingness of the special-effect presentation effect.

In the present embodiment, in a case where some effect adding conditions are met, a sound-mixing sound effect is determined for the video frame to be processed, and the sound-mixing audio may be determined in a plurality of manners. The advantages of such settings lie in that: since the sound-mixing audio is determined in the plurality of manners, the application range of the present solution is wider.
S220: determining an audio to be presented according to volume information corresponding to the audio information.

In the present embodiment, if audio content of a plurality of target objects is recorded in the audio information, the volume information of audios corresponding to the plurality of target objects is different, and at this time, audio tracks corresponding to the target objects in the sound-mixing audio may be determined based on the volume information. For example, the video frame to be processed includes the target object A and the target object B, the target object A is relatively more familiar with the current song, then the volume of the target object A following the singing is relatively large, the target object B is relatively less familiar with the current song, then the volume of the target object B following the singing is relatively small, at this time, the volume information of the target object A is stronger than the volume information of the target object B, and thus the audio information of the target object A may be used as the audio to be presented.
S230: determining the at least one sound-mixing audio and the audio to be presented as a target audio within a video frame to be processed.

In the present embodiment, dual-track playing is performed on the determined sound-mixing audio and the audio to be presented. That is, the target audio not only includes the sound-mixing audio, but also includes the audio for the target object with the relatively large volume information. The advantages of such settings lie in that: the audio information with a large volume can be enhanced, and the audio information with a small volume can be weakened, so that the played audio is more harmonious and pleasant to listen to.
S240: based on the target audio and at least one target object, determining an effect video frame corresponding to the video frame to be processed.

According to the technical solutions of the embodiments of the present disclosure, the sound-mixing audio corresponding to the at least one target object may be determined in a plurality of manners, that is, the at least one sound-mixing audio may be determined based on a trigger operation on at least one sound-mixing control on the display interface; the at least one sound-mixing audio may be determined according to the object attributes of the at least one target object; and the at least one sound-mixing audio may also be determined according to the audio information in the video frame to be processed.

The adaptability between the user and the sound-mixing audio determined in a plurality of manners is relatively high, and correspondingly, the target audio determined based on the sound-mixing audio and the audio information of the target object is closest to the actual effect, thereby improving the effect presentation performance, and expanding the application range of the present solution.

FIG. 5 is a schematic flowchart of a method for generating an effect video provided in an embodiment of the present disclosure. Based on the foregoing embodiments, richer presentation content is displayed in an effect presentation interface, and a vivid onsite atmosphere is created. For a specific implementation, reference may be made to the technical solutions in the present embodiment. Technical terms the same as or corresponding to those in the above embodiments are not described herein again. As shown in FIG. 5, the method includes the following steps:
S310: in response to detecting that a sound-mixing condition is met, determining at least one sound-mixing audio corresponding to at least one target object within a video frame to be processed.
S320: determining a target audio of the video frame to be processed based on the at least one sound-mixing audio and audio information of the at least one target object.
S330: determining at least one split-screen image corresponding to the at least one target object.

In the present embodiment, one or more target objects may be displayed in the video frame to be processed. If there is only one target object in the video frame to be processed, image content corresponding to the target object may be copied to obtain split-screen images, and the split-screen images are displayed at a preset position in a display interface. If there are a plurality of target objects in the video frame to be processed, the image content corresponding to the plurality of target objects may be copied as a whole to obtain the split-screen images, and the split-screen images are displayed in the display interface.

Optionally, each split-screen image includes at least one target object, or each split-screen image includes one target object.

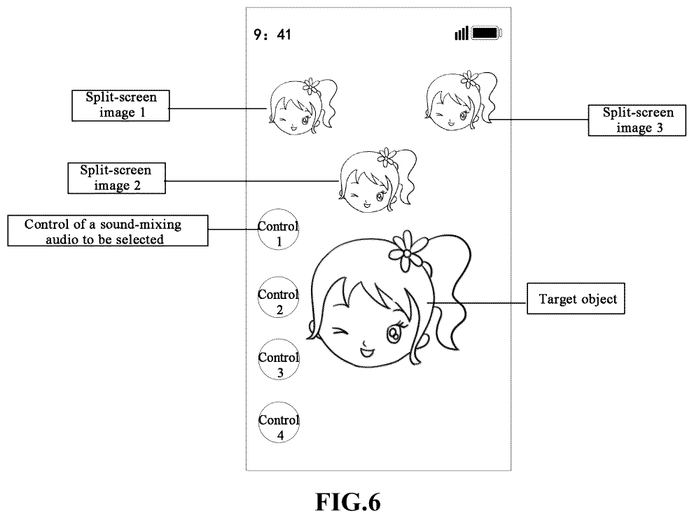

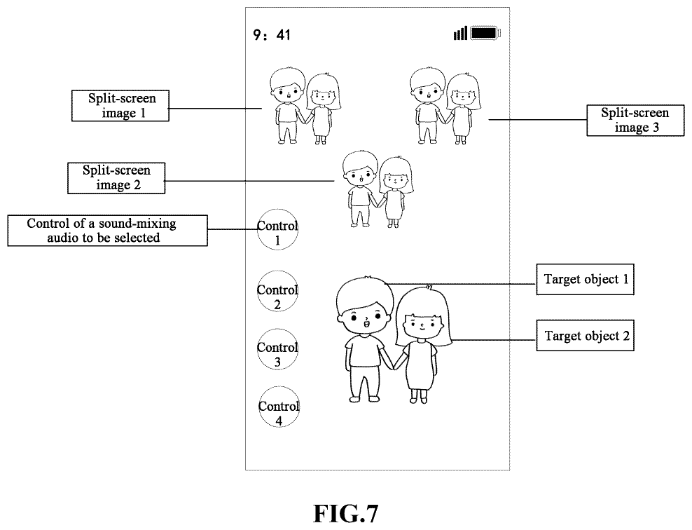

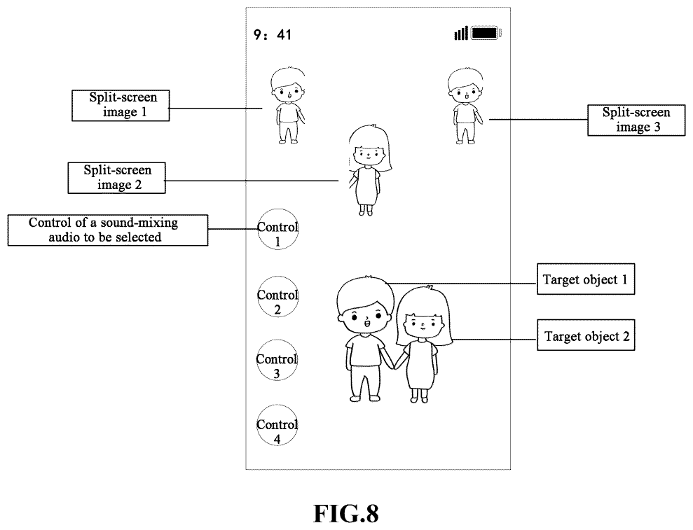

In the present embodiment, if there is only one target object in the video frame to be processed, the split-screen image may include one target object, referring to FIG. 6. If there are a plurality of target objects in the video frame to be processed, the split-screen image may be obtained in two manners: the first manner is to perform overall image matting on image content corresponding to the plurality of target objects, and the overall image matting content of the plurality of target objects is the split-screen image, referring to FIG. 7. The second manner is to perform splitting processing on the image content corresponding to the plurality of target objects, that is, to split the plurality of target objects into independent split-screen images and display the split-screen images on a preset position respectively, referring to FIG. 8. The advantages of such settings lie in that: the split-screen image may be determined according to the selection of the user regardless of the number of the target objects, thereby enhancing the use experience of the user.

The presentation effect of the target object in the display interface may also be: performing segmentation processing on the at least one target object to determine object-segmented images; and using the at least one target object as a center of the video frame to be processed, and displaying the object-segmented images on the two sides of the center in a stacked manner according to a preset scaling ratio, so as to update the effect video frame.

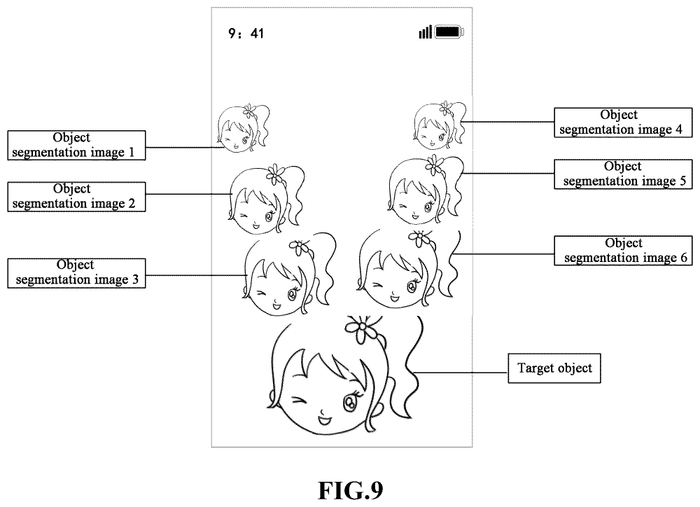

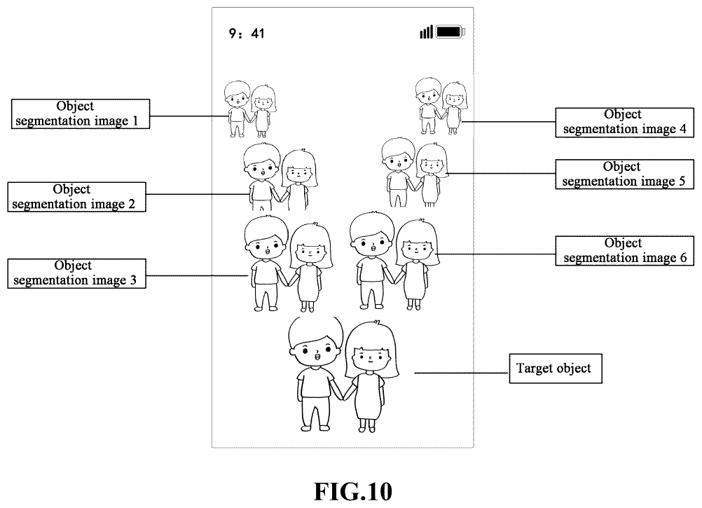

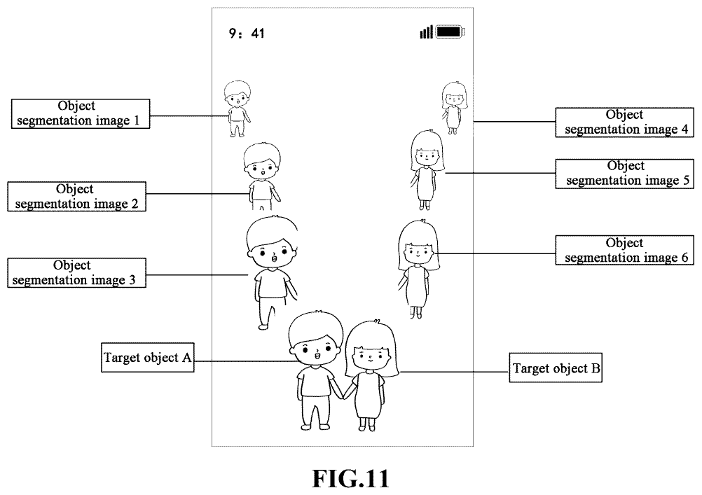

In the present embodiment, if there is only one target object in the video frame to be processed, segmentation processing may be performed on an image corresponding to the target object, then the target object is used as the center, and the object-segmented images are displayed on the two sides of the center in the stacked manner according to the preset scaling ratio, referring to FIG. 9. If there are a plurality of target objects in the video frame to be processed, overall segmentation processing may be performed on image content corresponding to the plurality of target objects, so as to obtain overall object-segmented images of the plurality of target objects, and the overall object-segmented images of the plurality of target objects are displayed on the two sides of the center in the stacked manner according to the preset scaling ratio, referring to FIG. 10. In addition, the segmentation processing may also be respectively performed on the plurality of target objects. For example, the video frame to be processed includes the target object A and the target object B, the segmentation processing is respectively performed on the target object A and the target object B, an overall image of the target object A and the target object B is used as a certain, object-segmented images corresponding to the target object A are stacked on the left side of the center according to the preset scaling ratio, and object-segmented images corresponding to the target object B are stacked on the right side of the center according to the preset scaling ratio, referring to FIG. 11, wherein the scaling ratio may be reducing by 20% based on the original image. The advantages of such settings lie in that: more object-segmented images are displayed in the effect presentation page, so that the special-effect presentation effect reflects a scene of onsite chorus, and the interestingness of the special-effect presentation effect is enhanced.
S340: determining an effect video frame based on the at least one split-screen image, the target audio and the video frame to be processed.

In the present embodiment, the split-screen image, the target audio and the video frame to be processed are overlaid as a whole to obtain an effect video frame having both an audio effect and an image effect, and then a plurality of effect video frames may be spliced to generate an effect video capable of presenting a chorus effect.

According to the technical solutions of the embodiments of the present disclosure, on the basis of performing effect processing on the audio, a plurality of split-screen images corresponding to the target object may be determined based on the target object, and then the split-screen images, the target audio and the video frame to be processed are overlaid as a whole to obtain the effect video frame having both the audio effect and the image effect. That is, in addition to performing the effect processing on the audio, the effect processing is further performed on the image corresponding to the at least one target object, thereby performing synchronous processing on the audio and the image to improve the display content of an effect picture, so that the special-effect presentation effect reflects the scene of onsite chorus, and the richness of picture content is improved.

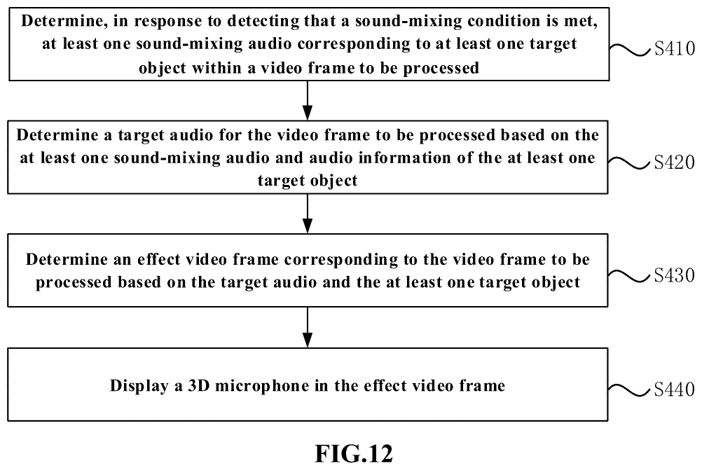

FIG. 12 is a schematic flowchart of another method for generating an effect video provided in an embodiment of the present disclosure. Based on the foregoing embodiments, a 3D microphone is displayed in an effect presentation interface, and the 3D microphone may be aligned with a target object in real time to create a vivid onsite atmosphere. For a specific implementation, reference may be made to the technical solutions in the present embodiment. Technical terms the same as or corresponding to those in the above embodiments are not described herein again. As shown in FIG. 12, the method specifically includes the following steps:
S410: in response to detecting that a sound-mixing condition is met, determining at least one sound-mixing audio corresponding to at least one target object within a video frame to be processed.
S420: determining a target audio for the video frame to be processed based on the at least one sound-mixing audio and audio information of the at least one target object.
S430: determining an effect video frame corresponding to the video frame to be processed based on the target audio and the at least one target object.
S440: displaying a 3D microphone in the effect video frame.

In the present embodiment, an alignment object corresponding to the 3D microphone is determined from the at least one target object, and a display position of the 3D microphone in the effect video frame is adjusted according to position information of the alignment object.

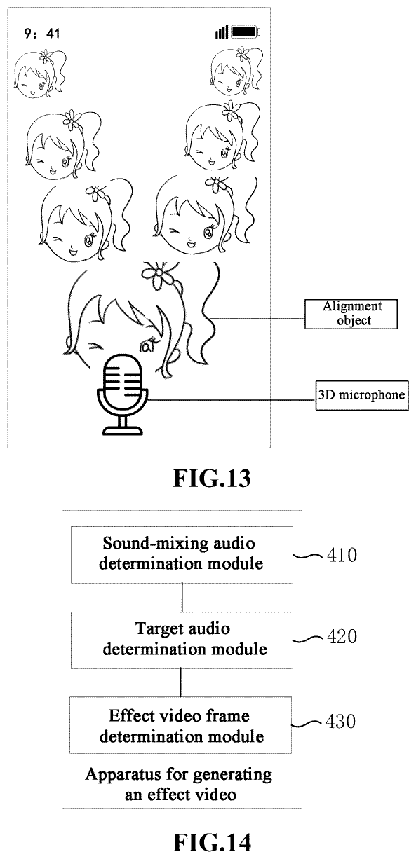

For example, for the position of the 3D microphone in the effect video frame, reference is made to FIG. 13. The advantages of such settings lie in that: the 3D microphone is displayed in an effect presentation page, so that the special-effect presentation effect is more vivid, and the richness of the special-effect presentation effect is enhanced.

Optionally, displaying the 3D microphone in the effect video frame may include the following steps: determining an alignment object corresponding to the 3D microphone from the at least one target object; and adjusting a microphone display position of the 3D microphone in the effect video frame according to target position information of the alignment object, wherein the microphone display position includes a deflection angle of the microphone and/or a display height of the microphone in the effect video frame. The advantages of such settings lie in that: the display position of the microphone may be adjusted according to the displacement of the target object, thereby improving the matching degree between the microphone and the alignment object, and thus enhancing the richness and interestingness of the special-effect presentation effect.

In an actual application process, there may be two manners for determining the alignment object, one manner is to determine the alignment object based on depth information of the image, and the other manner is to determine the alignment object based on a picture display proportion.

The implementation of determining the alignment object based on the picture display ratio includes: determining a display proportion, in a picture, of each target object in the video frame, wherein the target object with the maximum display proportion may be used as the alignment object. The implementation of determining the alignment object based on the depth information may be: the depth information may represent the distance between a camera and the user, and the closer the user is to the camera, the smaller the depth information is; and the farther the user is from the camera, the greater the depth information is. A depth image corresponding to each target object in the video frame to be processed is determined, a depth value corresponding to each point in a portrait of the target object is calculated, then an average value of the depth values of the portrait points is calculated, finally, the depth information of each target object is obtained, and the target object with the minimum depth information is used as the alignment object.

In the present embodiment, there may be a certain change in the display position of the alignment object in the video frame to be processed in the display interface, for example, there is a certain rotation angle and the like, and at this time, the display position of the 3D microphone may be adaptively adjusted according to the deflection angle of the alignment object. The target position information of the alignment object may be a preset fixed point, for example, may be a nasal tip fixed point of the target object. The determination process of the nasal tip fixed point is: firstly, tracking the position information of the nasal tip fixed point in real time based on a facial detection algorithm, and then adaptively adjusting the deflection angle of the 3D microphone according to the position information of the nasal tip fixed point and the deflection angle of a pre-defined reference line, so as to achieve the effect of tracking the alignment object in real time by the 3D microphone.

For example, the position information of the nasal tip fixed point may be represented by a spatial coordinate point, a normal line of the nasal tip fixed point may be determined based on spatial coordinates, the reference line corresponds to a normal line, then an included angle between a normal line of the nasal tip fixed point and the normal line corresponding to the reference line may be calculated, and the calculated included angle is the deflection angle of the microphone. The microphone adjusts its display position according to the deflection angle. Optionally, the range of the deflection angle may be fixed between [−30°, 30°]. That is, the deflection angle of the microphone may be determined based on the range of the deflection angle and the actual deflection angle.

In an actual use process, during a video filming process of the target user, the target user may be sometimes away from the camera and sometimes close to the camera, at this time, the display position of the target object in the video frame to be processed may have an up-and-down movement situation, so that a relative display height of the 3D microphone needs to be adjusted.

According to the technical solutions of the embodiments of the present disclosure, on the basis of performing synchronous effect processing on the audio and the image of the target object, the 3D microphone may also be displayed in real time in the effect video frame, and the display position of the 3D microphone in the display interface is adjusted based on the display position information of the target object, so that the 3D microphone and the target object are matched in real time, thereby achieving the effect of collecting the audio information of the target object based on the 3D microphone, improving the reality of the special-effect presentation effect, and further improving the interestingness of effect presentation.

FIG. 14 is a schematic structural diagram of an apparatus for generating an effect video provided in an embodiment of the present disclosure, as shown in FIG. 14, the apparatus includes: a sound-mixing audio determination module 510, a target audio determination module 520 and an effect video frame determination module 530.

The sound-mixing audio determination module 510 is configured to: in response to detecting that a sound-mixing condition is met, determine at least one sound-mixing audio corresponding to at least one target object within a video frame to be processed, wherein the video frame to be processed is a video frame collected in real time or a video frame in a recorded video; the target audio determination module 520 configured to determine a target audio for the video frame to be processed based on the at least one sound-mixing audio and audio information of the at least one target object; and the effect video frame determination module 530 is configured to determine an effect video frame corresponding to the video frame to be processed based on the target audio and the at least one target object.

Based on the above technical solutions, the sound-mixing condition includes at least one of the following: triggering an effect prop corresponding to a sound-mixing effect; a display interface includes the at least one target object; triggering a filming control; and detecting a recorded video that is uploaded based on a triggered video processing control.

Based on the above technical solutions, the sound-mixing audio determination module 510 includes at least one of the following: a trigger operation determination sub-module, an object attribute determination sub-module, and a sound-mixing audio determination sub-module.

The trigger operation determination sub-module is configured to determine the at least one sound-mixing audio based on a trigger operation on at least one sound-mixing control on the display interface, wherein the at least one sound-mixing control corresponds to at least one sound-mixing audio to be selected; the object attribute determination sub-module is configured to determine the at least one sound-mixing audio according to object attributes of the at least one target object; and the sound-mixing audio determination sub-module is configured to determine the at least one sound-mixing audio according to audio information in the video frame to be processed.

Based on the above technical solutions, the object attribute determination sub-module includes a face algorithm recognition unit and an attribute category determination unit.

The face algorithm recognition unit is configured to identify the object attributes of the at least one target object based on a facial detection algorithm; and the attribute category determination unit is configured to determine, based on the number of attribute categories of the object attributes and the object attributes, sound-mixing audios consistent with the number of attribute categories from at least one pre-made sound-mixing audio to be selected.

Based on the above technical solutions, the sound-mixing audio determination sub-module includes: a harmony melody determination unit and a sound-mixing audio determination unit.

The harmony melody determination unit is configured to determine a harmony melody according to accompaniment information of the audio information in the video frame to be processed and a target voice part in a harmony; and the sound-mixing audio determination unit is configured to determine the at least one sound-mixing audio based on tone information in the harmony melody and tone information in the audio information.

Based on the above technical solutions, the sound-mixing audio determination unit is configured to determine the at least one sound-mixing audio based on the tone information in the harmony melody, the tone information in the audio information, and the object attributes of the at least one target object.

Based on the above technical solutions, the sound-mixing audio includes a harmony accompaniment of at least one voice part, or the sound-mixing audio includes a harmony accompaniment of at least one voice part and an audio of a lead-singer audio track.

Based on the above technical solutions, the target audio determination module 520 includes a volume information determination sub-module and a target audio determination sub-module.

The volume information determination sub-module is configured to determine an audio to be presented according to volume information corresponding to the audio information; and the target audio determination sub-module is configured to use the at least one sound-mixing audio and the audio to be presented as the target audio for the video frame to be processed.

Based on the above technical solutions, the effect video frame determination module 530 includes a split-screen image determination sub-module and an effect video frame determination sub-module.

The split-screen image determination sub-module is configured to determine at least one split-screen image corresponding to the at least one target object; and the effect video frame determination sub-module is configured to determine the effect video frame based on the at least one split-screen image, the target audio and the video frame to be processed.

Based on the above technical solutions, each split-screen image includes at least one target object, or, each split-screen image includes one target object.

Based on the above technical solutions, the apparatus further includes: a segmentation image determination module and an effect video updating module.

The segmentation image determination module is configured to perform segmentation processing on the at least one target object to determine object-segmented images; and the effect video updating module is configured to use the at least one target object as a center of the video frame to be processed, and display the object-segmented images on the two sides of the center in a stacked manner according to a preset scaling ratio, so as to update the effect video frame.

Based on the above technical solutions, the apparatus further includes: a microphone display module, configured to display a 3D microphone in the effect video frame.

Based on the above technical solutions, the microphone display module further includes an alignment object determination sub-module and a microphone position adjustment sub-module.

The alignment object determination sub-module is configured to determine an alignment object corresponding to the 3D microphone from the at least one target object; and the microphone position adjustment sub-module is configured to adjust a microphone display position of the 3D microphone in the effect video frame according to target position information of the alignment object, wherein the microphone display position includes a deflection angle of the microphone and/or a display height of the microphone in the effect video frame.

According to the technical solutions of the embodiments of the present disclosure, in response to detecting that the sound-mixing condition is met, the at least one sound-mixing audio corresponding to the at least one target object in the video frame to be processed may be determined, then the target audio corresponding to a plurality of audio tracks may be determined based on the determined sound-mixing audio and the audio information of the at least one target object, and the final effect video frame may be obtained by performing fusion processing on the target audio and the target object. The technical effects of not only processing picture content, but also processing audio content can be realized, the richness and interestingness of the special-effect presentation effect are improved, and the technical effect of improving the use experience of the target user is further improved.

The apparatus for generating the effect video provided in the embodiments of the present disclosure may execute the method for generating the effect video provided in any embodiment of the present disclosure, and has corresponding functional modules and effects for executing the method.

The plurality of units and modules included in the above apparatus are only divided according to functional logic, but are not limited to the above division, as long as corresponding functions may be implemented; and in addition, the names of the plurality of units and modules are merely for ease of distinguishing from each other, and are not used to limit the protection scope of the embodiments of the present disclosure.

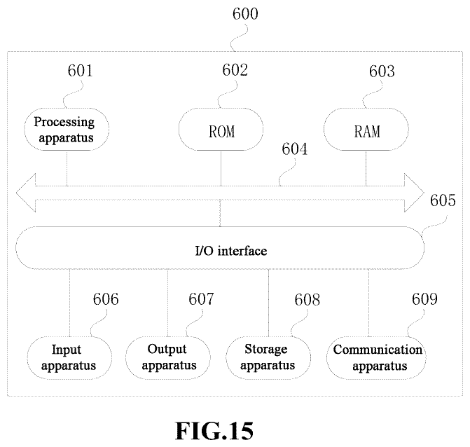

FIG. 15 is a structural schematic diagram of an electronic device provided in an embodiment of the present disclosure. Referring to FIG. 15, FIG. 15 illustrates a structural schematic diagram of an electronic device 600 (e.g., a terminal device or a server in FIG. 15) suitable for implementing an embodiment of the present disclosure. The terminal device in the embodiment of the present disclosure may include, but is not limited to, mobile terminals such as mobile phones, notebook computers, digital broadcast receivers, personal digital assistants (PDAs), portable Android devices (PADs), portable multimedia players (PMPs), in-vehicle terminals (e.g., in-vehicle navigation terminals), and the like, and fixed terminals such as digital TVs, desktop computers, etc. The electronic device shown in FIG. 15 is merely an example and should not bring any limitation to the functions and use ranges of the embodiments of the present disclosure.

As shown in FIG. 15, the electronic device 600 may include a processing apparatus (e.g., a central processing unit, a graphics processing unit, or the like) 601, which may execute various suitable actions and processing in accordance with a program stored in a read-only memory (ROM) 602 or a program loaded from a storage apparatus 608 into a random access memory (RAM) 603. In the RAM 603, various programs and data needed by the operations of the electronic device 600 are also stored. The processing apparatus 601, the ROM 602 and the RAM 603 are connected with each other via a bus 604. An input/output (I/O) interface 605 is also connected to the bus 604.

In general, the following apparatuses may be connected to the I/O interface 605: an input apparatus 606, including, for example, a touch screen, a touch pad, a keyboard, a mouse, a camera, a microphone, an accelerometer, a gyroscope, and the like; an output apparatus 607, including, for example, a liquid crystal display (LCD), a speaker, a vibrator, and the like; a storage apparatus 608, including, for example, a magnetic tape, a hard disk, and the like; and a communication apparatus 609. The communication apparatus 609 may allow the electronic device 600 to communicate in a wireless or wired manner with other devices to exchange data. Although FIG. 15 illustrates the electronic device 600 having various apparatuses, it should be understood that not all illustrated apparatuses are required to be implemented or provided. More or fewer apparatuses may alternatively be implemented or provided.

According to the embodiments of the present disclosure, the processes described above with reference to the flowcharts may be implemented as computer software programs. For example, the embodiments of the present disclosure include a computer program product, which includes a computer program carried on a non-transitory computer-readable medium, and the computer program includes program codes for executing the method illustrated in the flowcharts. In such embodiments, the computer program may be downloaded and installed from a network via the communication apparatus 609, or installed from the storage apparatus 608, or installed from the ROM 602. When the computer program is executed by the processing apparatus 601, the above functions defined in the method of the embodiments of the present disclosure are executed.

The names of messages or information interacted between a plurality of apparatuses in the embodiments of the present disclosure are for illustrative purposes only and are not intended to limit the scope of these messages or information.

The electronic device provided in the embodiment of the present disclosure and the method for generating the effect video provided in the above embodiments belong to the same inventive concept, technical details that not described in detail in the present embodiment may refer to the above embodiments, and the present embodiment has the same effects as the above embodiments.

An embodiment of the present disclosure provides a computer-readable storage medium, storing a computer program thereon, wherein the program, when executed by a processor, implements the method for generating the effect video provided in the above embodiments.

The computer-readable medium described above in the present disclosure may be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus or device, or a combination of any of the above. More specific examples of the computer-readable storage medium may include, but are not limited to: an electrical connection having one or more wires, a portable computer magnetic disk, a hard disk, an RAM, an ROM, an erasable programmable read-only memory (EPROM) or a flash memory, an optical fiber, a compact disc read-only memory (CD-ROM), an optical storage device, a magnetic storage device, or any suitable combination of the above. In the present disclosure, the computer-readable storage medium may be any tangible medium that includes or stores a program that may be used by or in combination with an instruction execution system, apparatus or device. In the present disclosure, the computer-readable signal medium may include a data signal that is propagated in a baseband or used as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transmit the program for use by or in combination with the instruction execution system, apparatus or device. Program codes contained on the computer-readable medium may be transmitted with any suitable medium, including, but not limited to: an electrical wire, an optical cable, radio frequency (RF), and the like, or any suitable combination thereof.

In some embodiments, a client and a server may perform communication by using any currently known or future-developed network protocol, such as a hypertext transfer protocol (HTTP), and may be interconnected with any form or medium of digital data communication (e.g., a communication network). Examples of the communication network include a local area network (LAN), a wide area network (WAN), an international network (e.g., the Internet), and a peer-to-peer network (e.g., an ad hoc peer-to-peer network), as well as any currently known or future-developed network.

The computer-readable medium may be contained in the above electronic device; and it may also be present separately and is not assembled into the electronic device.

The computer-readable medium carries one or more programs, when the one or more programs are executed by the electronic device, the electronic device is caused to: in response to detecting that a sound-mixing condition is met, determine at least one sound-mixing audio corresponding to at least one target object within a video frame to be processed, wherein the video frame to be processed is a video frame collected in real time or a video frame in a recorded video; determine a target audio for the video frame to be processed based on the at least one sound-mixing audio and audio information of the at least one target object; and determine an effect video frame corresponding to the video frame to be processed based on the target audio and the at least one target object.

Computer program codes for executing the operations of the present disclosure may be written in one or more programming languages or combinations thereof. The programming languages include, but are not limited to, object node-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer through any type of network, including an LAN or a WAN, or it may be connected to an external computer (e.g., through the Internet using an Internet service provider).

The flowcharts and block diagrams in the drawings illustrate system architectures, functions and operations of possible implementations of systems, methods and computer program products according to various embodiments of the present disclosure. In this regard, each block in the flowcharts or block diagrams may represent a part of a module, a program segment, or a code, which includes one or more executable instructions for implementing specified logical functions. It should also be noted that, in some alternative implementations, the functions annotated in the blocks may occur out of the order annotated in the drawings. For example, two blocks shown in succession may, in fact, be executed substantially in parallel, or the blocks may sometimes be executed in a reverse order, depending upon the functions involved. It should also be noted that each block in the block diagrams and/or flowcharts, and combinations of the blocks in the block diagrams and/or flowcharts may be implemented by dedicated hardware-based systems for executing specified functions or operations, or combinations of dedicated hardware and computer instructions.

The units and modules involved in the described embodiments of the present disclosure may be implemented in a software or hardware manner. The names of the units and modules do not constitute limitations of the units and modules themselves in a certain case. For example, a sound-mixing audio determination module may also be described as “a module for determining at least one sound-mixing audio corresponding to at least one target object within a video frame to be processed in response to detecting that a sound-mixing condition is met”.

The functions described herein above may be executed, at least in part, by one or more hardware logical components. For example, without limitation, example types of the hardware logical components that may be used include: a field programmable gate array (FPGA), an application specific integrated circuit (ASIC), an application specific standard product (ASSP), a system on chip (SOC), a complex programmable logic device (CPLD), and so on.

In the context of the present disclosure, a machine-readable medium may be a tangible medium, which may include or store a program for use by or in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium would include an electrical connection based on one or more wires, a portable computer disk, a hard disk, an RAM, an ROM, an EPROM or a flash memory, an optical fiber, a portable CD-ROM, an optical storage device, a magnetic storage device, or any suitable combination thereof.

According to one or more embodiments of the present disclosure, Example 1 provides a method for generating an effect video, including: in response to detecting that a sound-mixing condition is met, determining at least one sound-mixing audio corresponding to at least one target object within a video frame to be processed, wherein the video frame to be processed is a video frame collected in real time or a video frame in a recorded video; determining a target audio for the video frame to be processed based on the at least one sound-mixing audio and audio information of the at least one target object; and determining an effect video frame corresponding to the video frame to be processed based on the target audio and the at least one target object.

According to one or more embodiments of the present disclosure, Example 2 provides a method for generating an effect video, further including: optionally, determining the at least one sound-mixing audio based on a trigger operation on at least one sound-mixing control on a display interface, wherein the at least one sound-mixing control corresponds to at least one sound-mixing audio to be selected; determining the at least one sound-mixing audio according to object attributes of the at least one target object; and determining the at least one sound-mixing audio according to audio information in the video frame to be processed.

According to one or more embodiments of the present disclosure, Example 3 provides a method for generating an effect video, further including: optionally, determining the at least one sound-mixing audio according to the object attributes of the at least one target object includes: identifying the object attributes of the at least one target object based on a facial detection algorithm; and based on the number of attribute categories of the object attributes and the object attributes, determining sound-mixing audios consistent with the number of attribute categories from at least one pre-made sound-mixing audio to be selected.

According to one or more embodiments of the present disclosure, Example 4 provides a method for generating an effect video, further including: optionally, determining the at least one sound-mixing audio according to the audio information in the video frame to be processed includes: determining a harmony melody according to accompaniment information of the audio information in the video frame to be processed and a target voice part in a harmony; and determining the at least one sound-mixing audio based on tone information in the harmony melody and tone information in the audio information.

According to one or more embodiments of the present disclosure, Example 5 provides a method for generating an effect video, further including: optionally, determining the at least one sound-mixing audio based on the tone information in the harmony melody and the tone information in the audio information includes: determining the at least one sound-mixing audio based on the tone information in the harmony melody, the tone information in the audio information, and the object attributes of the at least one target object.

According to one or more embodiments of the present disclosure, Example 6 provides a method for generating an effect video, further including: optionally, the sound-mixing audio includes a harmony accompaniment of at least one voice part, or the sound-mixing audio includes a harmony accompaniment of at least one voice part and an audio of a lead-singer audio track.

According to one or more embodiments of the present disclosure, Example 7 provides a method for generating an effect video, further including: optionally, determining the target audio for the video frame to be processed based on the at least one sound-mixing audio and the audio information of the at least one target object includes: determining an audio to be presented according to volume information corresponding to the audio information; and using the at least one sound-mixing audio and the audio to be presented as the target audio for the video frame to be processed.

According to one or more embodiments of the present disclosure, Example 8 provides a method for generating an effect video, further including: optionally, determining the effect video frame corresponding to the video frame to be processed based on the target audio and the at least one target object includes: determining at least one split-screen image corresponding to the at least one target object; and determining the effect video frame based on the at least one split-screen image, the target audio and the video frame to be processed.

According to one or more embodiments of the present disclosure, Example 9 provides a method for generating an effect video, further including: optionally, each split-screen image includes at least one target object, or, each split-screen image includes one target object.

According to one or more embodiments of the present disclosure, Example 10 provides a method for generating an effect video, further including: optionally, performing segmentation processing on the at least one target object to determine object-segmented images; and using the at least one target object as a center of the video frame to be processed, and displaying the object-segmented images on the two sides of the center in a stacked manner according to a preset scaling ratio, so as to update the effect video frame.

According to one or more embodiments of the present disclosure, Example 11 provides a method for generating an effect video, further including: optionally, displaying a 3D microphone in the effect video frame.

According to one or more embodiments of the present disclosure, Example 12 provides a method for generating an effect video, further including: optionally, determining an alignment object corresponding to the 3D microphone from the at least one target object; and adjusting a microphone display position of the 3D microphone in the effect video frame according to target position information of the alignment object, wherein the microphone display position includes a deflection angle of the microphone and/or a display height of the microphone in the effect video frame.

According to one or more embodiments of the present disclosure, Example 13 provides a method for generating an effect video, further including: optionally, the sound-mixing condition includes at least one of the following: triggering an effect prop corresponding to a sound-mixing effect; the display interface includes the at least one target object; triggering a filming control; and detecting a recorded video that is uploaded based on a triggered video processing control.

According to one or more embodiments of the present disclosure, Example 14 provides an apparatus for generating an effect video, including: a sound-mixing audio determination module, configured to: in response to detecting that a sound-mixing condition is met, determine at least one sound-mixing audio corresponding to at least one target object within a video frame to be processed, wherein the video frame to be processed is a video frame collected in real time or a video frame in a recorded video; a target audio determination module, configured to determine a target audio for the video frame to be processed based on the at least one sound-mixing audio and audio information of the at least one target object; and an effect video frame determination module, configured to determine an effect video frame corresponding to the video frame to be processed based on the target audio and the at least one target object.

Although various operations are described in a particular order, this should not be understood as requiring that these operations are executed in the particular order shown or in a sequential order. In certain environments, multitasking and parallel processing may be advantageous. Similarly, although specific implementation details have been included in the above discussion, these should not be construed as limiting the scope of the present disclosure. Some features that are described in the context of separate embodiments may also be implemented in combination in a single embodiment. Various features that are described in the context of a single embodiment may also be implemented in a plurality of embodiments separately or in any suitable sub-combination.

Although the present theme has been described in language specific to structural features and/or methodological actions, it should be understood that the theme defined in the appended claims is not necessarily limited to the specific features or actions described above. The specific features and actions described above are merely example forms for implementing the claims.

1. A method of generating an effect video, comprising:
determining, in response to detecting that a sound-mixing condition is met, at least one sound-mixing audio corresponding to at least one target object within a video frame to be processed, wherein the video frame to be processed is a video frame collected in real time or a video frame in a recorded video;
determining, based on the at least one sound-mixing audio and audio information of the at least one target object, a target audio for the video frame to be processed; and
determining, based on the target audio and the at least one target object, an effect video frame corresponding to the video frame to be processed.

2. The method according to claim 1, wherein determining the at least one sound-mixing audio comprises at least one of the following manners:
determining, based on a trigger operation on at least one sound-mixing control on a display interface, the at least one sound-mixing audio, wherein the at least one sound-mixing control corresponds to at least one sound-mixing audio to be selected;
determining, according to object attributes of the at least one target object, the at least one sound-mixing audio; or
determining, according to audio information in the video frame to be processed, the at least one sound-mixing audio.

3. The method according to claim 2, wherein determining the at least one sound-mixing audio according to the object attributes of the at least one target object comprises:
identifying, based on a facial detection algorithm, the object attributes of the at least one target object; and
determining, based on the number of attribute categories of the object attributes and the object attributes, the at least one sound-mixing audio from at least one pre-made sound-mixing audio to be selected.

4. The method according to claim 2, wherein determining the at least one sound-mixing audio according to the audio information in the video frame to be processed comprises:
determining a harmony melody according to accompaniment information of the audio information and a target voice part in a harmony in the video frame to be processed; and
determining the at least one sound-mixing audio based on tone information in the harmony melody and tone information in the audio information.

5. The method according to claim 4, wherein determining the at least one sound-mixing audio based on the tone information in the harmony melody and the tone information in the audio information comprises:
determining the at least one sound-mixing audio based on the tone information in the harmony melody, the tone information in the audio information, and the object attributes of the at least one target object.

6. The method according to claim 1, wherein each sound-mixing audio comprises a harmony accompaniment of at least one voice part, or each sound-mixing audio comprises a harmony accompaniment of at least one voice part and an audio of a lead-singer audio track.

7. The method according to claim 1, wherein determining the target audio for the video frame to be processed based on the at least one sound-mixing audio and the audio information of the at least one target object comprises:
determining an audio to be presented according to volume information corresponding to the audio information; and
determining the at least one sound-mixing audio and the audio to be presented as the target audio for the video frame to be processed.

8. The method according to claim 1, wherein determining the effect video frame corresponding to the video frame to be processed based on the target audio and the at least one target object comprises:
determining at least one split-screen image corresponding to the at least one target object; and
determining the effect video frame based on the at least one split-screen image, the target audio and the video frame to be processed.

9. The method according to claim 8, wherein each split-screen image comprises at least one target object, or, each split-screen image comprises one target object.

10. The method according to claim 1, further comprising:
performing segmentation processing on the at least one target object to determine object-segmented images; and
taking the at least one target object as a center of the video frame to be processed, and displaying the object-segmented images on two sides of the center in a stacked manner according to a preset scaling ratio to update the effect video frame.

11. The method according to claim 1, further comprising:
displaying a 3D microphone in the effect video frame.

12. The method according to claim 1, further comprising:
determining an alignment object corresponding to the 3D microphone from the at least one target object; and
adjusting, according to target position information of the alignment object, a microphone display position of the 3D microphone in the effect video frame,
wherein the microphone display position comprises at least one of: a deflection angle of the microphone and a display height of the microphone in the effect video frame.

13. The method according to claim 1, wherein the sound-mixing condition comprises at least one of the following:
triggering an effect prop corresponding to a sound-mixing effect;
the display interface comprises the at least one target object;
triggering a filming control; and
detecting a recorded video that is uploaded based on a triggered video processing control.

14. (canceled)

15. An electronic device, comprising:
at least one processor; and
a storage apparatus, configured to store at least one program,
wherein the at least one program, when executed by the one or more processors, cause the at least one processor to:
determine, in response to detecting that a sound-mixing condition is met, at least one sound-mixing audio corresponding to at least one target object within a video frame to be processed, wherein the video frame to be processed is a video frame collected in real time or a video frame in a recorded video;
determine, based on the at least one sound-mixing audio and audio information of the at least one target object, a target audio for the video frame to be processed; and
determine, based on the target audio and the at least one target object, an effect video frame corresponding to the video frame to be processed.

16. A non-transitory computer readable storage medium, comprising computer-executable instructions, wherein the computer-executable instructions, when executed by a computer processor, are configured to:
determine, in response to detecting that a sound-mixing condition is met, at least one sound-mixing audio corresponding to at least one target object within a video frame to be processed, wherein the video frame to be processed is a video frame collected in real time or a video frame in a recorded video;
determine, based on the at least one sound-mixing audio and audio information of the at least one target object, a target audio for the video frame to be processed; and
determine, based on the target audio and the at least one target object, an effect video frame corresponding to the video frame to be processed.

17. The electronic device according to claim 15, wherein the at least one processor is caused to determine the at least one sound-mixing audio by at least one of:
determining, based on a trigger operation on at least one sound-mixing control on a display interface, the at least one sound-mixing audio, wherein the at least one sound-mixing control corresponds to at least one sound-mixing audio to be selected;
determining, according to object attributes of the at least one target object, the at least one sound-mixing audio; or
determining, according to audio information in the video frame to be processed, the at least one sound-mixing audio.

18. The electronic device according to claim 17, wherein the at least one processor is caused to determine the at least one sound-mixing audio according to the object attributes of the at least one target object by:
identifying, based on a facial detection algorithm, the object attributes of the at least one target object; and
determining, based on the number of attribute categories of the object attributes and the object attributes, the at least one sound-mixing audio from at least one pre-made sound-mixing audio to be selected.

19. The electronic device according to claim 17, wherein the at least one processor is caused to determine the at least one sound-mixing audio according to the audio information in the video frame to be processed by:
determining a harmony melody according to accompaniment information of the audio information and a target voice part in a harmony in the video frame to be processed; and
determining the at least one sound-mixing audio based on tone information in the harmony melody and tone information in the audio information.

20. The electronic device according to claim 19, wherein the at least one processor is caused to determine the at least one sound-mixing audio based on the tone information in the harmony melody and the tone information in the audio information by:
determining the at least one sound-mixing audio based on the tone information in the harmony melody, the tone information in the audio information, and the object attributes of the at least one target object.

21. The electronic device according to claim 15, wherein each sound-mixing audio comprises a harmony accompaniment of at least one voice part, or each sound-mixing audio comprises a harmony accompaniment of at least one voice part and an audio of a lead-singer audio track.
